(19) United States
(12) Patent Application Publication
(10) Pub. No.: US 2011/0258963 A1
(43) Pub. Date: Oct. 27, 2011

(54) System and method for construction of a floor slab and a roof slab

(76) Inventor: Javed Sultan, Lexington, MA (US)

(21) Appl. No.: 13/066,209

(22) Filed: Apr. 8, 2011

Related U.S. Application Data
(60) Provisional application No. 61/343,267, filed on Apr. 26, 2010.

(51) Int. Cl. E04G 11/36; B29C 33/42; E04B 1/02

(52) U.S. Cl. 52/745.05; 249/18; 264/219

(57) ABSTRACT

This invention features a system for construction of a floor or roof slab. The system includes a starter mold configured to span a floor opening or a roof opening. The starter mold includes a first skin configured to form a diaphragm and a second skin attached to the first skin configured to reinforce the first skin.

### RELATED APPLICATIONS

This application hereby claims the benefit of and priority to U.S. Provisional Application Ser. No. 61/343,267, filed on Apr. 26, 2010 under 35 U.S.C. §§119, 120, 363, 365, and 37 C.F.R. §1.55 and §1.78, incorporated by reference herein.

### FIELD OF THE INVENTION

This invention relates to a system and method for the construction of a floor slab and a roof slab.

### BACKGROUND OF THE INVENTION

Structures, such as walls, roof slabs, floor slabs, columns, supports, foundations, and the like, are typically manufactured using one or more of a variety of materials, such as wood, steel, reinforced concrete, brick, mud, and the like. Such structures are typically built to not only support the required dead loads and various type of live loads but oftentimes such structures must withstand wind loads and loads from earthquakes or other natural disasters. The floor and roof slab pose special challenge in that a thin diaphragm is required to take loads perpendicular to its primary axis, e.g., the horizontal plane or at some specified inclination to the horizontal axis. For a poured in place floor or roof slab constructed using conventional methods, the wet concrete for the slab must be supported by shuttering and scaffolding until the cast-in-situ concrete cures. The shuttering is usually made of metal deck or wood deck and supported by steel scaffolding pipes or wood columns. Considerable effort and expense go into placing the support system to enable curing and removal of same after the slab is cured. Moreover, the area below the floor or roof slab cannot be utilized until the floor or roof slab has cured to the desired strength. This wastes time and money.

### BRIEF SUMMARY OF THE INVENTION

This invention features a system for construction of a floor or roof slab, the system including a starter mold configured to form a floor slab or a roof slab. The starter mold includes a first skin configured to form a diaphragm of a predetermined shape, and a second skin attached to the first skin configured to reinforce the first skin.

In one embodiment, the first skin may include a flexible membrane configured to form the predetermined shape. The predetermined shape may include a parabolic, semi-circular shape, a hyperbola shape, a dome shape, or a non-symmetrical parabolic shape. The flexible membrane may be made one or more of: steel mesh, plastic fabric, epoxy fabric, composite fabric, carbon fabric, and organic fabric. The gage of the flexible membrane layer may be configured to improve strength and spanning capabilities of the floor slab or the roof slab. The first skin may include a thin coating of a reinforcing material over the flexible membrane. The reinforcing material may include one or more of: concrete, epoxy, cementitious plaster, or a composite material including inorganic and/or organic resins forming a bonding material. The predetermined shape of the first skin may form a void. The second skin may include reinforcing bars configured to improve strength and spanning capabilities of the floor slab or the roof slab. The second skin may include a thin coating of a reinforcing material configured to embed the reinforcing bars therein and improve strength and spanning capabilities of the floor slab or the roof slab. The reinforcing material may include cement, coarse sand, and coarse gravel. The system may include a finish skin over the starter mold. The floor slab or the roof slab may be configured to span a floor or roof opening having a length in the range of about six inches to about 18 feet to about 24 feet. The system may include a third skin attached to the starter mold configured to reinforce the starter mold. The system may include a fourth skin attached to the third skin configured to reinforce the starter mold. The third skin may include reinforcing bars configured to improve strength and spanning capabilities of the floor slab or the roof slab. The fourth skin may include a thin film coating of a reinforcing material configured to embed the reinforcing bars therein and improve strength and spanning capabilities of the floor slab or the roof slab. The reinforcing material may include concrete. The system may include a finish skin over the fourth skin. The floor slab or the roof slab may be configured to span a floor or roof opening having a length greater than about 18 feet to about 24 feet. The system may include a casting subsystem configured to create the starter mold. The casting subsystem may include a frame, and a flexible membrane attached to the top of the box frame configured to form a mold having a predetermined shape for creating the first skin. The predetermined shape may include a parabolic, semi-circular shape, a hyperbola shape, a dome shape, or a non-symmetrical parabolic shape. The system may include a plurality of starter molds placed between a floor or roof opening configured to form a composite slab which defines the floor slab or the roof slab. The floor slab or the roof slab may be configured as an inclined diaphragm.

This invention also features a method for construction of a floor slab or a roof slab, the method including providing a starter mold configured to span a floor or roof opening, the starter mold including a first skin configured to form a diaphragm and a second skin attached to the first skin configured to reinforce the first skin, and placing the starter mold over a floor opening or a roof opening to form a floor slab or a roof slab.

In one embodiment, the method may include the step of forming a finish layer or the second skin. The method may include the step of forming a third skin over the starter mold. The method may include the step of forming a fourth skin over the third skin. The method may include the step of forming a finish layer of the fourth skin. The method may include the step of placing a plurality of starter molds over a floor or roof opening to form a composite slab which defines the floor slab or the roof slab. The method may include the step of providing a starter mold includes: providing a frame, attaching a flexible membrane to the frame to form a mold of a predetermined shape for forming the first skin, applying a thin coating of a reinforcing material over the flexible membrane to form the first skin, attaching a reinforcing bars to the first skin, and applying a thin coating of a reinforcing material over the reinforcing bars to form the second skin.

This invention features a method of manufacturing a starter mold configured to form a floor or roof slab. The method comprises: providing a frame, attaching a flexible membrane to the frame to form a mold of a predetermined shape for forming a first skin of the starter mold, applying a thin coating of a reinforcing material over the flexible membrane to form the first skin, attaching a reinforcing bars to the first skin, and applying a thin coating of a reinforcing material over the reinforcing bars to form a second skin.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a three-dimensional view of one embodiment of a starter mold of the system for construction of a floor slab and a roof slab of this invention;

FIG. 2 is three-dimensional view showing one example of two starter molds shown in FIG. 1 in place over floor or roof opening;

FIG. 3 is three-dimensional view showing one example of a plurality of starter molds shown in FIG. 1 in place over floor or roof opening and showing one example of a finish skin which may be placed over the starter molds;

FIG. 4 is three-dimensional view showing another embodiment of a finish skin which may be formed over the starter molds shown in FIG. 3;

FIG. 5 is three-dimensional view of another embodiment of the starter mold of the system shown in FIGS. 1-4 including third and fourth skins for construction of a floor slab and a roof slab of this invention;

FIG. 6 is three-dimensional view showing one example of a plurality of starter molds with third and fourth skins shown in FIG. 5 in place over a floor or roof opening; and

FIG. 7 is three-dimensional view of one embodiment of a starter mold casting subsystem used to construct the starter mold in FIGS. 1-6.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

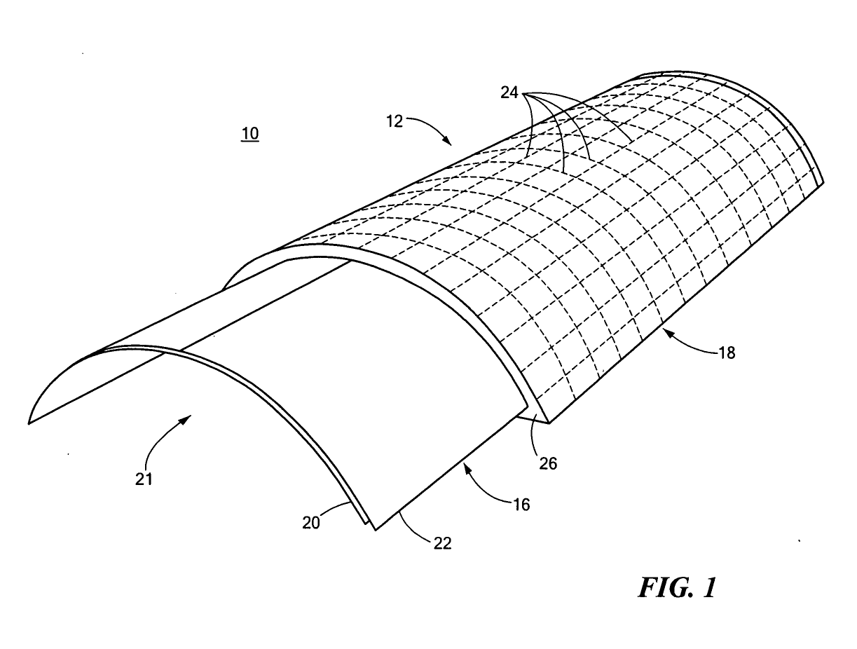

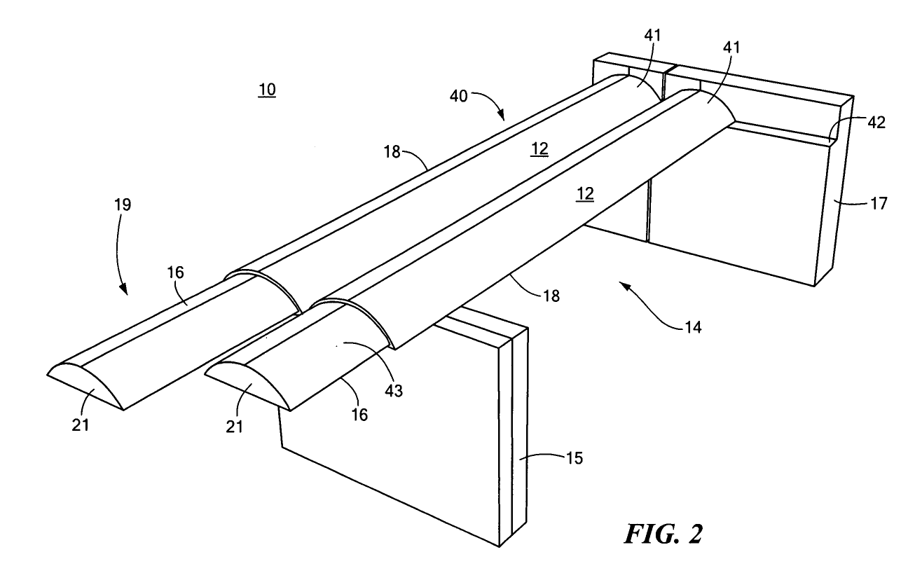

There is shown in FIG. 1 one embodiment of system 10 and the method thereof for the construction of a floor slab and/or a roof slab. System 10 includes starter mold 12 configured to span a floor or roof opening, e.g., floor opening 14, FIG. 2, between walls 15 and 17. Starter mold 12 may also span more than two walls, e.g., as shown by the area extending at 19. Starter mold 12, FIG. 1, includes first skin 16 configured to form a diaphragm and second skin 18 attached to first skin 16. First skin 16 preferably has parabolic, semi-circular shape as shown. First skin 16 may also have a hyperbola shape, a dome shape, a non-symmetrical parabolic shape, or any other similar type shape as required by design criteria and based on anticipated design loads. First skin 16 preferably includes flexible membrane 20 preferably made of steel mesh, plastic fabric, epoxy fabric, composite fabric, carbon fabric, or organic fabric, such as jute or cotton. First skin 16 also preferably includes thin coating 22 of reinforcing material over flexible membrane 20. In one example, coating 22 of reinforcing material may be made of concrete, epoxy, cementitious plastic, or a composite material including inorganic and/or organic resins forming a bonding material applied over flexible membrane 20. In one design, coating 22 is about 1/8 inch to about 1/4 inch thick. First skin 16 acts as a semi-elastic diaphragm which has both tensile and compressive properties. The thickness, or gage, of membrane 20 of first skin 16 and/or the thickness of coating 22 of second skin 18 may be dependent on the type of bonding material utilized, e.g., concrete, cement plaster, epoxy bond, and the like, and partially determines the strength and spanning capability of starter mold 12. A greater gage of flexible member 20 and an increased thickness of coating 22 will improve the strength and spanning capability of starter mold 12 and the floor slab or roof slab made therefrom.

Second skin 18 is formed over first skin 16 and preferably includes reinforcing bars 24 (shown in phantom), e.g., rebar made of steel or similar type materials. Reinforcing bars 24 of second skin 18 may be both longitudinal and radially spaced as shown and vaulted at designed spacing. Second skin 18 also preferably includes coating 26, e.g., concrete that embeds reinforcing bars 24 therein. In one example, coating 26 may be about 1/4 inch to 3/4 inch thick and made of cement and coarse sand in proportions as required for the designed strength. The thickness coating 26 may vary based on whether the area of the vault is in compression or in tension. The strength of bars 24 and the thickness of coating 26 also partially determine the strength and spanning capability of starter mold 12 and the floor slab or roof slab made therefrom. Starter mold 12 with first skin 16 and second skin 18 is preferably capable of supporting significant dead and live loads, such those imposed by the placing of wet concrete on cured starter mold 12 with first skin 16 and second skin 18. The cured concrete of first skin 16 and second skin 18 is engaged in compression and tension also protects the reinforcing bars 24, e.g., made of steel, from corrosion and also provides the required bonding between the inelastic (concrete) and elastic (steel) materials. Steel reinforcement bars 24 and second skin 18 are primarily stressed in tension. The tensile material of flexible membrane 20 and coating 22 of first skin 16, bars 24 and coating 26 in second skin 18 provide starter mold 12 with a degree of elasticity and may add to its compressive and tensile strength.

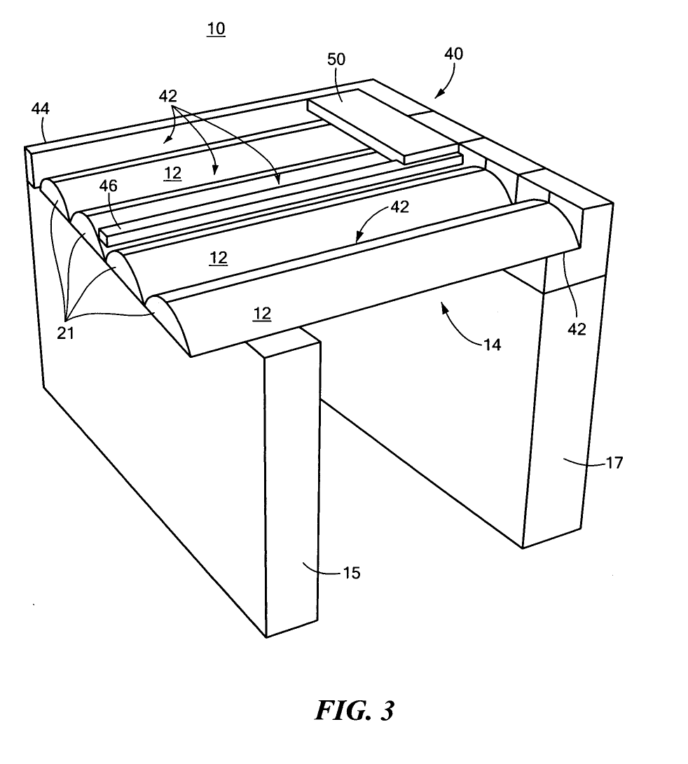

Starter mold 12 preferably spans floor or roof opening 14, FIG. 2, e.g., between opposing walls 15 and 17. One end of starter mold 12, e.g., end 41 may be placed on shelf 42 of wall 17 and end 43 may span another wall, e.g., wall 15, or be placed on another shelf of an opposing wall (not shown). Preferably, a plurality of starter molds 12, FIG. 3, may be placed between opposing walls, e.g., walls 15 and 17, to form floor slab or roof slab 40. Floor or roof slab 40 becomes the primary load-bearing structure. Each of first skin 16 and second skin 18 assist each other in carrying superimposed loads using the diaphragm design as shown. Floor or roof slab 40 may span walls that are about 6 inches apart to about 18 feet to about 24 feet apart. Floor or roof slab 40 of system 10 typically weighs about 30% to 40% less than conventional floor or roof slabs.

The shape of starter mold 12 with first skin 16 and second skin 18 preferably form vault 21, FIGS. 1-3. Vault(s) 21 creates a void underneath first skin 16 which may become a void for heating ventilation, air conditioning (HVAC) ductwork, electrical and plumbing piping, conduits for communication and other utilities, insulation, and the like to be located. Voids 42, FIG. 3, between adjacent starter molds 12 or between starter mold 12 and perimeter beam 44 may also be used for similar type functions and for placing insulation, or utility conduits, e.g., insulation 46.

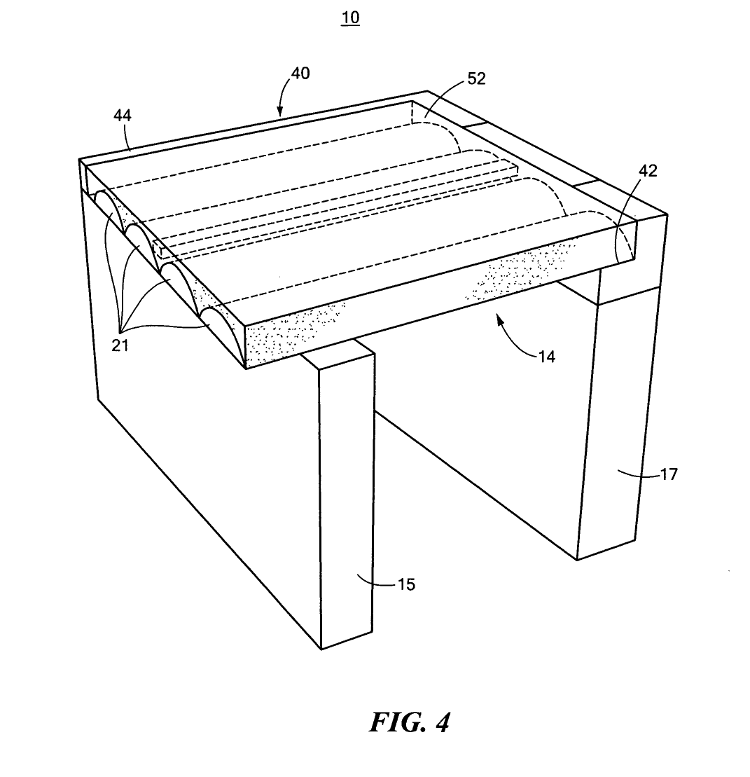

System 10, FIG. 3, may include finish skin 50, FIG. 3, e.g., planks made of wood, plastic, concrete, steel, or similar type material which form a finished floor or roof top. In another design, finish skin 50 may be concrete poured over the plurality of adjacent starter molds 12 in place over a floor or roof opening to form a finished floor or roof top, e.g., finished floor 52, FIG. 4.

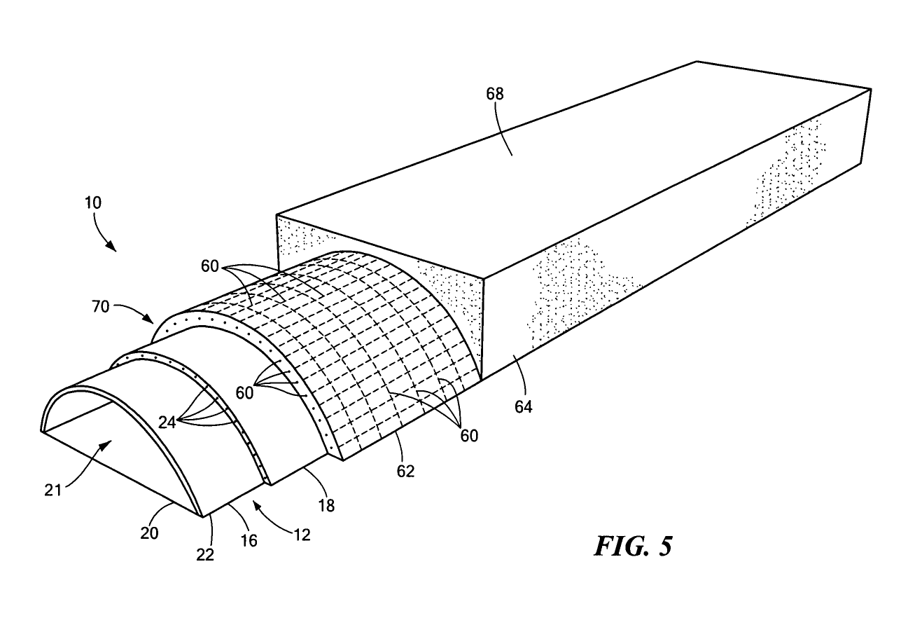

When additional strength and spanning capability is needed, e.g., beyond about 18 feet to about 24 feet, system 10, FIG. 5, where like parts have like numbers, may include third skin 60 (shown partially in phantom) preferably made of reinforcing bars, e.g., rebar made of steel or similar type materials, and shaped as a reinforcement cage as shown. Third skin 60 is preferably secured to second skin 18 of starter mold 12 by wires or similar type attachments (not shown).

System 10 may also includes fourth skin 62, e.g., concrete or similar type material, poured over third skin 60 to embed for third skin therein. In one example fourth skin 62 may be about 1.5 inches to about 2 inches thick. The mixture of the concrete for fourth skin 62 preferably includes cement, coarse sand, and coarse gravel. The gravel preferably includes about 1/4 inch to about 1- 1/2 inches of stone or brick aggregate.

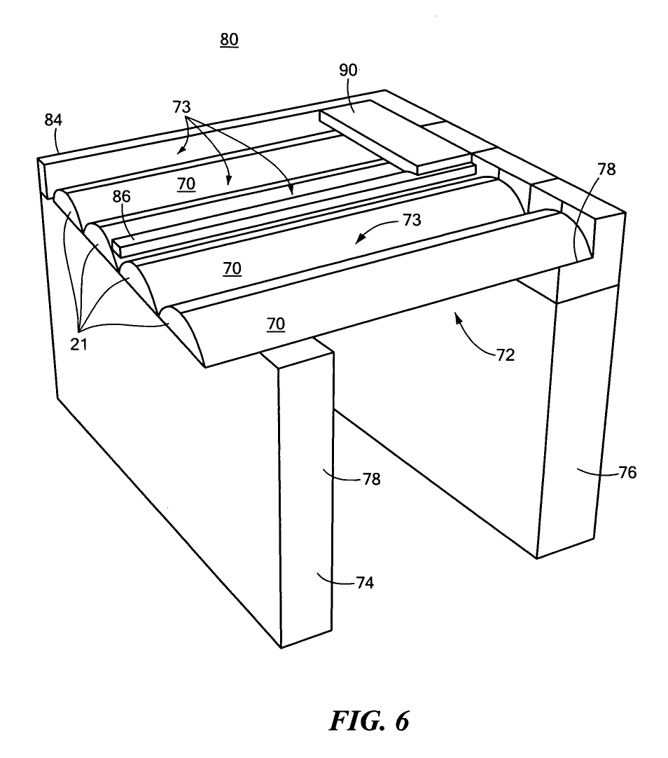

In this example, starter mold 12 with first skin 16 and second skin 18, third skin 60, and fourth skin 62 preferably adhere to each other and form a composite slab or shell structure, e.g., composite slab 70. Similar as discussed above, a plurality of composite slabs 70, FIG. 6, may be placed over floor or roof opening 72 between opposing walls 74 and 76 to form floor or roof slab 80. One end of each of composite slabs 70 may be placed on shelf 78 of wall 76 and the other end may span wall 74 or be placed on another shelf of an opposing wall. Composite slab 70 becomes the primary load-bearing structure. Each of the skins 16, 18, 60, and 62 assists each other in carrying superimposed loads using a diaphragm design. Floor or roof slab 80 is preferably used to span opposing walls that are spaced apart by more than about 18 feet to about 24 feet. Floor or roof slab 80 of system 10 preferably weighs about 30% to 40% less than conventional floor or roof slabs.

Similar, as discussed above, the shape of first skin 16 of composite slab 70 forms vault(s) 21, FIGS. 3 and 6 which becomes a void for heating ventilation, air conditioning (HVAC) ductwork, electrical and plumbing piping, conduits for communication and other utilities, and the like to be located. Voids 73, FIG. 6, between adjacent composite slabs 70 or between composite slab 70 and perimeter beam 84 may also be used for similar type functions and for placing insulation, e.g., insulation 86.

System 10, FIGS. 5 and 6 may also include finish skin 64, which may be poured over fourth skin 62 to form a flat floor or roof surface 68, FIG. 5, on which the final floor or roof finish is applied. In one example, concrete may be poured over the plurality of composite slabs 70, FIG. 6 to form a finished floor or roof slab. In other examples, planks 90, FIG. 6, made of wood, plastic, steel, concrete, or similar type material, may be used to form the finished floor slab or roof top.

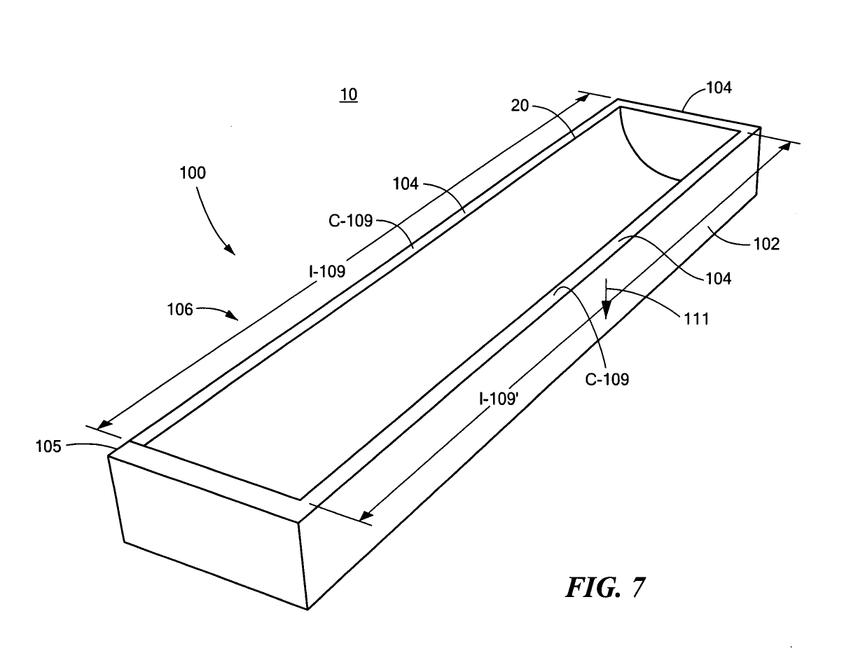

System 10, FIGS. 1-6, may include starter mold casting subsystem 100, FIG. 7, which is used to manufacture starter mold 12, FIGS. 1-6, with first skin 16 and second skin 18. Subsystem 100, FIG. 7, preferably includes frame 102 made of wood, angle iron, or similar type materials. Flexible membrane 20, e.g., as discussed above with reference to FIG. 1, may be attached to top 104, FIG. 7, of frame 102. Flexible membrane 20 is preferably shaped to form a permanent mold on which to cast first skin 16. In one design, the edge 104 of frame 102 of frame 102 may have a slight deflection downwards from ends 105 and 107 towards center c-109, as shown by arrow 111, to give the first skin a slight camber. When the starter mold is cambered, the vault depth is greater at the center than at the ends. The camber may vary from about 1/2 inch to several inches depending on the length of the skin. The camber allows first skin 16 to be constructed to have a slight camber along its length thereby allowing most of the concrete to work in compression. Frame 102 and flexible membrane 20 form mold 106 which provides the desired shape and curvature of starter mold 12 with first skin 16 and second skin 18, e.g., a parabolic, semi-circular shape, a hyperbola shape, a dome shape, or a non-symmetrical parabolic shape or other similar type shapes as required by design criteria and based on anticipated design loads. As discussed above, flexible membrane 20 may made of steel mesh, plastic, fabric, carbon fabric, or organic fabric. In other examples, when a mold 12 is needed to cast a slab with a water barrier, flexible membrane 20 may be made of tarpaulin, sheet metal, or a similar type material, or wood decking lined with a waterproof membrane, made of rubber, plastic, sheet metal, and the like.

After flexible membrane 20 is secured in place in frame 102, a coating, e.g., about 1/8 inch to 1/4 inch thick, of concrete, epoxy, cementitious plastic, or a composite material including inorganic and/or organic resins forming a bonding material is applied to flexible membrane 20. After the concrete hardens it forms layer 22, FIG. 1, of first skin 16. As discussed above, first skin 16 acts as a diaphragm which has both tensile and compressive properties. Second skin 18 is preferably formed over the first skin within mold 106, FIG. 7, or after first skin 16 has been placed on the floor or roof opening. In one example, the second skin may include reinforcing bars, e.g., rebar made of steel or similar type materials that are tied to the first skin, e.g., reinforcing bars 24 (shown in phantom), FIG. 1, of second skin 18. Reinforcing bars 24 may be placed over and secured to the first skin both longitudinal and vaulted at designed spacing. The reinforcing bars may be attached to the first skin using wire and other attachment devices.

Then, an additional thin coating of concrete is applied over the reinforcing bars to form complete second skin 18, e.g., coating 26, FIG. 1. In one example a thin coating, e.g., about 1/4 inch to 3/4 inch thick, of a mixture of cement, coarse sand, and coarse gravel in proportions as required for the designed strength is applied over reinforcing bars 24. The thickness may vary based on whether the area of the vault is in compression or in tension. The concrete is then allowed to cure in mold 106, FIG. 7, to form starter mold 12, FIG. 1, with first skin 16 and second skin 18. Starter mold 12 with conjoined first skin 16 and second skin 18 are capable of supporting significant dead and live loads, such those imposed by the placing of wet concrete on the cured first and second skins. Starter mold 12, FIG. 1, is preferably prefabricated on the ground, upside down, in mold 106, FIG. 7.

In operation, the cured starter mold in mold 106, FIG. 7, is overturned and placed between opposing walls, e.g., as discussed above with reference to FIGS. 2-4, to form floor slab or a roof slab 40.

In one embodiment, when additional strength and spanning capabilities are needed, e.g., greater than about 18 feet to about 24 feet, starter mold 12 becomes the mold for third skin 60, FIGS. 5 and 6, fourth skin 62, and/or finish skin 64, which are constructed on top of starter mold 12. As discussed above, the various layers of skins are stacked on top of each other.

In another example, first skin 16 may be fabricated in mold 106, FIG. 7, as discussed above, cured, and overturned. Then, second skin 18 may be formed over first skin 16 to create starter mold 12, in a similar manner as discussed above.

Although as discussed above with reference to FIGS. 1-7, system 10 may be used to construct a floor or roof slab, this is not a necessary limitation of this invention, as system 10 may be used to construct any similar type of horizontal or inclined diaphragm utilized in building structures. An inclined diaphragm as used herein may be defined as any horizontal surface at less than 90 degrees inclination from the horizontal.

The result is system 10 of one or more embodiments of this invention provides a floor or roof slab which can spans from about 6 inches to about 30 feet and more. The floor or roof slab of system 10 may weigh about 30% to 40% less than conventional floor or roof slabs. This eliminates the need for shuttering and scaffolding below the floor slab or roof slab and makes the space thereunder usable for scheduled construction activities, which saves time and money. All the components of system 10 may be made of one homogenous material, e.g., reinforced concrete, or similar type homogenous material. System 10 can save on steel reinforcement, the amount of concrete utilized, and the foundation systems. Most of the concrete in the floor or roof slab is preferably in compression. Therefore, steel may not be required to take the dead load of concrete below the neutral plane, as found in conventional rectangular slabs. The wood utilized for conventional slab scaffolding has a significant impact on deforestation in most countries. System 10 and method thereof uses very little wood which helps reduce global warming. The decking and steel pipes utilized in typical conventional slab construction have a very high endowed carbon value and very negative impact on the eco-system. System 10 and method thereof helps reduce such problems.

System 10 and method thereof discussed above may be used to form and/or adapt to any span and being supported by any wall or column type. System 10 and the method thereof may be designed for both seismic and non-seismic loads and building structures. Starter mold 12 has a minimal weight which allows it to be placed over the floor or roof span manually or by using lightweight lifting equipment. This permits the creation of the composite slab in terms of manageable layers. The layers created may have a continuous layer of plaster or may they have voids, stub outs, mesh like diaphragm, and deformations to create a better mechanical bond between the various skins. The vault created may be a beam or a horizontal surface supporting the final floor covering.

The floor slab and roof slab constructed in accordance with one or more embodiment of this invention does not have to be rectangular with one side narrow than the other. The floor and roof slabs constructed in accordance with the system and method of this invention may also be square, circular, or any similar type shape. The floor and roof slabs may be made in sections, such as four quarters, ⅛^{th} slice of a dome and conjoined to form a monolithic slab structure after pouring of a monolithic slab on top of the starter mold.

Existing structures may be adapted to include various embodiments of the invention. For example, one embodiment of system 10 and the method thereof may be used for retrofitting existing slabs. In this example, the floor or roof slab can be placed below an existing floor slab and the new slab and older slab anchored to each other by mechanically with bolts and anchors thus creating a new composite floor slab of a higher load bearing capacity. This may be useful in converting a slab which is not designed for seismic event or blast protection and converting them to a stronger slab capable of responding to the new design objectives and performance criteria. It should be appreciated that retrofitting existing structures is not limited to retrofitting slab only, as other structures, e.g., walls may also be retrofitted.

This invention is not limited in its application to the details of construction and the arrangement of components set forth in the following description or illustrated in the drawings. The invention is capable of other embodiments and of being practiced and being carried out in various ways. Also, the phraseology and terminology used herein is for the purpose of description and should not be regarded as limiting. The use of “including,” “comprising,” “having”, “involving,” and/or variations thereof herein, is meant to encompass the items listed thereafter and equivalents thereof as well as additional items.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

Other embodiments will occur to those skilled in the art and are within the following claims.

What is claimed is:

1. A system for construction of a floor or roof slab, the system comprising:
a starter mold configured to form a floor slab or a roof slab, the starter mold including:
a first skin configured to form a diaphragm of a predetermined shape, and
a second skin attached to the first skin configured to reinforce the first skin.

2. The system of claim 1 in which the first skin includes a flexible membrane configured to form the predetermined shape.

3. The system of claim 2 in which the predetermined shape includes a parabolic, semi-circular shape, a hyperbola shape, a dome shape, or a non-symmetrical parabolic shape.

4. The system of claim 2 in which the flexible membrane is made one or more of: steel mesh, plastic fabric, epoxy fabric, composite fabric, carbon fabric, and organic fabric.

5. The system of claim 4 in which the gage of the flexible membrane layer is configured to improve strength and spanning capabilities of the floor slab or the roof slab.

6. The system of claim 1 in which the first skin includes a thin coating of a reinforcing material over the flexible membrane.

7. The system of claim 6 in which the reinforcing material includes one or more of: concrete, epoxy, cementitious plaster, or a composite material including inorganic and/or organic resins forming a bonding material.

8. The system of claim 3 in which the predetermined shape of the first skin forms a void.

9. The system of claim 1 in which the second skin includes reinforcing bars configured to improve strength and spanning capabilities of the floor slab or the roof slab.

10. The system of claim 9 in which the second skin includes a thin coating of a reinforcing material configured to embed the reinforcing bars therein and improve strength and spanning capabilities of the floor slab or the roof slab.

11. The system of claim 10 in which the reinforcing material includes cement, coarse sand, and coarse gravel.

12. The system of claim 1 further including a finish skin over the starter mold.

13. The system of claim 1 in which the floor slab or the roof slab is configured to span a floor or roof opening having a length in the range of about six inches to about 18 feet to about 24 feet.

14. The system of claim 1 further including a third skin attached to the starter mold configured to reinforce the starter mold.

15. The system of claim 14 further including a fourth skin attached to the third skin configured to reinforce the starter mold.

16. The system of claim 14 in which the third skin includes reinforcing bars configured to improve strength and spanning capabilities of the floor slab or the roof slab.

17. The system of claim 16 in which the fourth skin includes a thin film coating of a reinforcing material configured to embed the reinforcing bars therein and improve strength and spanning capabilities of the floor slab or the roof slab.

18. The system of claim 17 in which the reinforcing material includes concrete.

19. The system of claim 15 further including a finish skin over the fourth skin.

20. The system of claim 15 in which the floor slab or the roof slab is configured to span a floor or roof opening having a length greater than about 18 feet to about 24 feet.

21. The system of claim 1 further including a casting subsystem configured to create the starter mold.

22. The system of claim 8 in which the casting subsystem includes:
a frame, and
a flexible membrane attached to the top of the box frame configured to form a mold having a predetermined shape for creating the first skin.

23. The system of claim 22 in which the predetermined shape includes a parabolic, semi-circular shape, a hyperbola shape, a dome shape, or a non-symmetrical parabolic shape.

24. The system of claim 1 further including a plurality of starter molds placed between a floor or roof opening configured to form a composite slab which defines the floor slab or the roof slab.

25. The system of claim 1 in which the floor slab or the roof slab may be configured as an inclined diaphragm.

26. A method for construction of a floor slab or a roof slab, the method comprising:
providing a starter mold configured to span a floor or roof opening, the starter mold including a first skin configured to form a diaphragm and a second skin attached to the first skin configured to reinforce the first skin; and
placing the starter mold over a floor opening or a roof opening to form a floor slab or a roof slab.

27. The method of claim 26 further including the step of forming a finish layer or the second skin.

28. The method of claim 26 further including the step of forming a third skin over the starter mold.

29. The method of claim 28 further including the step of forming a fourth skin over the third skin.

30. The method of claim 29 further including the step of forming a finish layer of the fourth skin.

31. The method of claim 26 further including the step of placing a plurality of starter molds over a floor or roof opening to form a composite slab which defines the floor slab or the roof slab.

32. The method of claim 26 in which the step of providing a starter mold includes:
providing a frame;
attaching a flexible membrane to the frame to form a mold of a predetermined shape for forming the first skin;
applying a thin coating of a reinforcing material over the flexible membrane to form the first skin;
attaching a reinforcing bars to the first skin; and
applying a thin coating of a reinforcing material over the reinforcing bars to form the second skin.

33. A method of manufacturing a starter mold configured to form a floor or roof slab, the method comprising:
providing a frame;
attaching a flexible membrane to the frame to form a mold of a predetermined shape for forming a first skin of the starter mold;
applying a thin coating of a reinforcing material over the flexible membrane to form the first skin;
attaching a reinforcing bars to the first skin; and
applying a thin coating of a reinforcing material over the reinforcing bars to form a second skin.
